(19) United States
(12) Patent Application Publication
(10) Pub. No.: US 2009/0067310 A1
(43) Pub. Date: Mar. 12, 2009

(54) STORAGE MEDIUM, PREFERABLY FOR A CARRIER, AND READING DEVICE AND METHOD FOR READING THE STORAGE MEDIUM

(75) Inventors: Stefan Borgsmuller, Heidelberg (DE); Steffen Noehte, Weinheim (DE); Kay Schulte-Wieking, Heidelberg (DE)

Correspondence Address: NORRIS, MCLAUGHLIN & MARCUS, 875 THIRD AVE, 18TH FLOOR, NEW YORK, NY, 10022, US

(73) Assignee: TESA SCRIBOS GMBH, HEIDELBERG (DE)

(21) Appl. No.: 12/282,829

(22) PCT Filed: Apr. 2, 2007
(86) PCT No.: PCT/EP07/02939

§ 371 Date: Oct. 3, 2008

(30) Foreign Application Priority Data
Apr. 4, 2006 (DE) 10 2006 015 604.8

(51) Int. Cl. G11B 7/00

(52) U.S. Cl. 369/94; 369/103; G9B/7

(57) ABSTRACT

The invention relates to a storage medium, preferably a carrier. The aim of the invention is to make manipulation of data information of the storage medium or of non-authorized copies of the storage medium visible. For this purpose, the storage medium comprises a transparent layer and a layer produced from an opaque material, the layer of the opaque material having a section with a medium transmittance between 0% and 100% which is semi-transparent to electromagnetic radiation and an informative content comprising the value of the medium transmittance being stored in the storage medium.

The invention relates to a storage medium, preferably for a carrier, and a reading device and a method for reading the storage medium.

The prior art discloses storage media having partly transparent sections having both transparent and non-transparent locations. Through the arrangement or sequence of the transparent and non-transparent locations of the partly transparent section, it is possible to store information in the storage medium. In order to read out the information content of the storage medium, the partly transparent section is irradiated with electromagnetic radiation. In transmission, generally coded data information then arises, depending on the configuration of the partly transparent section.

One form of configuration consists in embodying the arrangement of the transparent and non-transparent locations as a computer-generated hologram. Computer-generated holograms comprise one or more layers of dot matrices or dot distributions which, upon illumination with a preferably coherent light beam, lead to a reconstruction of the information coded in the hologram. In this case, the dot distribution can be calculated as an amplitude hologram, phase hologram or as a kinoform, Fourier or Fresnell hologram. In order to produce computer-generated holograms, the latter are firstly calculated and subsequently written to a storage medium by a suitable writing device by means of dotwise introduction of energy. The resolution of the resultant dot matrix can be in the range of down to less than 1 μm. Consequently, holograms having a high resolution can be written in a confined space, the information of which holograms can only be read out by illumination with a light beam and reconstruction of the diffraction pattern. In this case, the size of the holograms can be between less than 1 mm² and plural 1 cm².

The computer-generated holograms described above can be combined with directly visible information (microscript, microimages, coded information).

The prior art discloses a plurality of writing devices for writing computer-generated holograms which write the optical structures of the holograms in planar storage media. By way of example, reference is made in this respect to the documents WO 02/079881, WO 02/079883, WO 02/084404, WO 02/084405 and WO 03/012549.

A plurality of reading devices are likewise known which are suitable for making the reconstruction visible by illuminating the hologram area by means of a light beam and a suitable optical unit or making it electronically representable and evaluatable by means of pick-up means. By way of example, reference is made here to the documents DE 101 37 832, WO 02/084588 and WO 2005/111913.

In the case of storage media of this type there is often uncertainty as to whether the data stored on the storage medium correspond to the original data and/or whether the storage medium is an original storage medium. Neither a manipulation concerning the data information nor a copy of the storage medium can readily be identified.

Therefore, the present invention is based on the technical problem of providing a storage medium, a reading device and a method for reading a storage medium such that a manipulation of the data information of the storage medium or a copy of the storage medium produced by a non-authorized entity can be identified.

This technical problem is solved according to the invention, in the case of a storage medium, preferably for a carrier, comprising a transparent layer and a layer of an opaque material,

by virtue of the fact that the layer of the opaque material has a partly transparent section having an average transmittance of between 0% and 100% for electromagnetic radiation, and
that an information content comprising the magnitude of the average transmittance is stored in the storage medium.

The storage medium according to the invention can be a storage medium of a variety of types, forms and sizes. However, it is always at least partly transparent to electromagnetic radiation.

Furthermore, the storage medium is preferably designed to be arranged on a carrier. However, the storage medium can, in principle, also be used without an additional carrier as an independent storage medium provided that the latter is made sufficiently stable.

Since the storage medium according to the invention can be made comparatively small, it can be used together with a carrier with which the data information of the storage medium is coordinated or to which said information refers. Consequently, the storage medium can be used for example in a manner similar to the bar codes arranged on products or packagings and, throughout the transport or throughout the use of the products, make available product-specific, individualized information as required for various purposes.

The storage medium can alternatively or additionally also serve as an authenticity feature for the actual carrier. In this case, the carrier can be an essentially arbitrary product, the packaging thereof, a credit card, an entrance ticket, an identity card or any other document whose authenticity should be verifiable. In the case of the carrier, care should merely be taken to ensure that the electromagnetic radiation can penetrate through the transparent locations of the partly transparent section if appropriate together with the carrier.

The data information and/or the information content of a storage medium can be stored in the storage medium inter alia as a letter sequence, number sequence, 1D or 2D bar code and/or image or imaging (silhouette image). The latter may be of interest particularly in the case of use with a personalized carrier. In principle, it is possible to use all types—known in the prior art—of coding of data information which can be stored by means of a sequence of transparent and non-transparent locations, which can also be referred to as pixels on account of their preferably small size. For writing and reading such data information it is possible, in principle, to use devices such as have already been discussed in the introduction in connection with computer-generated holograms.

The transparent layer can be a plastic which firstly serves for fixing the opaque material and secondly governs the desired mechanical properties of the storage medium. By contrast, the opaque material is preferably a metallic material which can then be vapor-deposited as a thin layer onto the transparent layer.

That section of the storage medium in which the transparent and non-transparent locations are provided is referred to as a partly transparent section since electromagnetic radiation penetrates through it only at the transparent locations, that is to say only partly.

The larger the transparent area proportion of the partly transparent section, the larger, too, that proportion of the total radiation impinging on the partly transparent section which penetrates through the partly transparent section. This proportion is also referred to as the transmittance and has a value of less than 100% and greater than 0% in the case of the storage medium according to the invention. In this case, a value of 100% corresponds to total transparency, while radiation no longer penetrates through in the case of a value of 0%.

Preferably, the transmittance is set with a relative accuracy of less than 5%. The transmittance can be set with percentage accuracy particularly by means of a device as described in DE 10 2006 015 609 A1. A high accuracy in the setting of the transmittance is desirable in this case in order that the subsequent checking of the storage medium for authenticity can be performed as reliably as possible.

For the partly transparent section of the storage medium written to, a specific average transmittance results depending on the coding method used and on the data information as such. Said average transmittance can either be determined afterward or calculated beforehand. The latter option makes it possible for the information content comprising the magnitude of the average transmittance to be written to the storage medium in parallel with the actual data information.

The fact of whether a specific storage medium is an original storage medium and/or a storage medium having the original data information can now be established very easily. For this purpose, the average transmittance of the partly transparent section is determined and the magnitude of the average transmittance is read out from the stored information content. If both values of the average transmittance are identical, the storage medium is with high probability an original storage medium or a storage medium having the original data information.

In the case of subsequently altered data information, different values of the average transmittance would have arisen in the course of the comparison described above. If a storage medium provided only with a copy of the data information had been presented instead of the original storage medium, the information content comprising the original magnitude of the average transmittance could not have been read out. Consequently, no comparison could have been made between read-out transmittance and determined transmittance. The method is similar to that of a checksum in digital coding, but here is determined optically in an analogue manner. In order to be free of disturbances due to dirt or other disturbances, preferably at least two regions that differ in gray-scale value are reserved as calibration fields representing a specific gray-scale value. Consequently, the gray-scale values of the coded information can be determined during the read-out despite disturbance.

In order that, in the case of a manipulation of the data information, an adaptation of the information content comprising the magnitude of the average transmittance is not readily possible or the information content comprising the magnitude of the average transmittance cannot readily be copied together with the actual data information, the corresponding information content should be stored in a secure manner.

It is appropriate here to afford the possibility for instance of a coding which can readily also take up a comparatively large amount of storage space. For it is only necessary to code the information content containing the magnitude of the average transmittance. The actual data information per se does not require storage-space-intensive coding, with the result that a very high storage density can be obtained overall.

In order to considerably increase the outlay needed to manipulate the data information or the storage medium per se, it may be provided that the actual data information and the information content containing the magnitude of the average transmittance are read out and/or written in different ways. Either different parameters are used for the read-out and/or writing, or provision is even made of a different device and/or a different functional principle for the writing and reading of the data information, on the one hand, and the information content containing the average transmittance, on the other hand.

The outlay needed to manipulate the data information or the storage medium per se can also be increased by the data information being individualized. This is because then if it does not suffice to be able to duplicate one and the same storage medium in large quantities.

The storage medium suffices as an authenticity feature as required even without the specific data information stored in the storage medium. An arbitrary areal distribution of transparent and non-transparent locations (pixels) is then provided in the partly transparent section without specific data information being assigned to said distribution. The average transmittance of this partly transparent section is nevertheless measurable and also stored as such in the storage medium.

In one preferred embodiment, the information content containing the magnitude of the average transmittance is provided in the partly transparent section. In this way it is not readily evident that the storage medium actually contains information about the magnitude of the average transmittance of the partly transparent section. Moreover, it is not readily evident where this information content is stored on the storage medium. The information content can ultimately be arranged in a manner “hidden” in the partly transparent section. For this purpose, it is preferably coded in a different manner than the rest of the data information.

The areal distribution of the transmittance within the partly transparent section furthermore preferably contains the information content comprising the magnitude of the average transmittance. Said information content is then preferably contained in a manner coded in the areal profile of the transmittance between two points of the partly transparent section, that is to say for example in the form of a specific sequence of high and low transmittances or corresponding transmission plateaus.

The average value of the transmittance between the two points can preferably likewise correspond to the magnitude of the average transmittance of the partly transparent section. This can be used for an alternative determination of the average transmittance or as an additional parameter in determining the authenticity of the storage medium or the data information thereof.

In a particularly preferred storage medium, at least one part of the partly transparent section is a computer-generated hologram containing the information content comprising the magnitude of the average transmittance. This is because such a hologram cannot readily be manipulated or copied. Moreover, a corresponding hologram can be provided without being directly discernible as such. By way of example, the hologram can be read only by means of electromagnetic radiation of a specific wavelength lying for instance in the range of IR or UV radiation.

Preferably, the entire partly transparent section is embodied as at least one hologram that preferably likewise contains the rest of the data information. The copying of the data information as such is then already made more difficult. In principle, the use of at least one transmission hologram is preferred here.

Individualized data information is also preferred in connection with the use of at least one hologram since a considerable outlay is then required just for simply copying the data information. The outlay required for copying is also very high in the case of very fine or small holograms of the order of magnitude of a few micrometers or less.

As an alternative or in addition, the storage medium can also have a section having a homogeneous transmittance of 100%, which can serve for calibrating a reading device for reading the storage medium. If the storage medium is moved during read-out relative to the reading device used for this, the 100% transparent section can alternatively or additionally also serve as a trigger for the start and/or the end of a determination of the average transmittance of the corresponding partly transparent section.

Instead of the 100% transparent section or in addition to the latter, a non-transparent section having a homogeneous transmittance of 0% can also be provided. In this case, this section can fulfill the same functions as the 100% transparent section with regard to calibration and/or triggering.

It is particularly preferred, however, if both a 100% transparent section and a 0% transparent section are jointly provided. The two homogeneous sections then preferably adjoin the partly transparent section at two mutually opposite sides. It is thus possible to trigger a start and an end of a determination of the average transmittance of the partly transparent section of the storage medium and, in addition, to carry out a two-point calibration for the transmittances 0% and 100%.

The accuracy of the calibration can also be increased by means of at least one additional partly transparent section having a predetermined homogeneous transmittance of between 0% and 100%. This holds true particularly when the storage medium as such has a nonlinear behavior with regard to the transmission properties. It goes without saying that, in principle, at least one section having a predetermined homogeneous transmittance of between 0% and 100% can also be used as an alternative to at least one of the sections described having a homogeneous transmittance of 0% and/or 100%.

Even in the case where the storage medium has highly nonlinear transmission properties, it is possible to obtain very good results with regard to the read-out accuracy of the storage medium if four additional partly transparent sections each having different predetermined, homogeneous transmittances of between 0% and 100% are provided. Depending on the application, the transmittances of the additional partly transparent sections can either be distributed uniformly over the range of values between 0% and 100% or be concentrated on a section of this range of values.

The suitability of the storage medium, in particular as an authenticity feature, can be improved for example by virtue of the fact that the partly transparent section has a different transmittance of between 0% and 100% for electromagnetic radiation of a shorter wavelength (λ≦λₖ) and of a longer wavelength (λ≦λ₁, λₖ<<λ₁). This property of the storage medium is preferably achieved by providing, in the partly transparent section, holes in the layer of opaque material having different effective diameters. The corresponding holes are then in each case transmissive only to such electromagnetic radiation which has a wavelength smaller than the effective diameters of the holes. If the shorter wavelength λₖ is smaller than the diameters of the holes, the transmittance is significantly greater for the shorter wavelength than for the longer wavelength.

An information content comprising the magnitudes of the average transmittance for at least two different wavelengths can then be stored in the storage medium. The authenticity of the storage medium is then exhibited only for the case where the average transmittances determined by the predetermined wavelengths correspond to the magnitudes of the average transmittances that are stored for corresponding wavelengths in the storage medium.

The technical problem mentioned in the introduction is solved, in the case of a reading device for reading a storage medium, by virtue of the fact that a radiation source, a sensor unit and a read-out unit connected to the sensor unit are provided, that the radiation source irradiates the storage medium at least in sections with electromagnetic radiation, that the sensor unit at least partly picks up the radiation after impingement on the storage medium and outputs a signal to the read-out unit, that the read-out unit determines an average transmittance of a partly transparent section of the storage medium at least from part of the signal, that the read-out unit, at least from part of the signal, reads out the magnitude of the average transmittance from an information content stored in the storage medium, and that the read-out unit compares the average transmittance determined and the read-out magnitude of the average transmittance with one another.

The reading device according to the invention requires only a radiation source, a sensor unit and a read-out unit. The reading device can therefore be provided in a cost-effective manner and in high numbers.

The radiation source serves to irradiate the storage medium, which need not be irradiated in its entirety. It suffices for the storage medium to be irradiated line by line.

Part of the radiation impinging on the storage medium penetrates through the transparent locations of the storage medium and is at least partly picked up by a sensor unit. All known sensor units, for instance those having photocells or a camera, are appropriate as the sensor unit. In addition, depending on the radiation picked up, the sensor unit forwards a corresponding signal, which preferably correlates with the transmittance, to the read-out unit.

The read-out unit then determines the average transmittance of the partly transparent section from at least one part of the signal. The read-out unit furthermore reads out the magnitude of the average transmittance from the same part of the signal or else from a different signal. The average transmittance determined and the read-out magnitude of the average transmittance are subsequently compared with one another by the read-out unit.

The result of this comparison can then be displayed by means of a suitable display device and/or be used for controlling a subsequent method. The method may be a sorting method, for instance, in which the storage media or carriers are sorted depending on the result of the comparison of the transmittances.

In a preferred reading device, only the partly transparent section is irradiated by the radiation source in a targeted manner. Furthermore, the sensor unit picks up only the transmission of this radiation, wherein the read-out unit, from the signal thereby generated, on the one hand determines the average transmittance and on the other hand reads out the stored magnitude of the average transmittance. It is therefore not necessary to radiate further regions of the storage medium and to pick up the corresponding radiation for instance by means of a second sensor.

Furthermore, the magnitude of the average transmittance is read out from the areal distribution of the transmittance that is picked up between two points. In this case, the magnitude of the average transmittance is written to the storage medium, in particular in correspondingly coded form.

It is particularly preferred if the magnitude of the average transmittance is read out from a reconstruction of a computer-generated hologram. If the hologram represents the partly transparent section as such, the average transmittance of the hologram is detected and the magnitude of the average transmittance is preferably obtained simultaneously from the reconstruction of said hologram.

In order to be able to read a multiplicity of storage media successively, a movement device for moving the radiation source and the storage media relative to one another can be provided. Preferably, the radiation source is fixably installed, the storage media being moved past the radiation source. However, it is also conceivable for the radiation source to emit electromagnetic radiation in temporally varying directions in order thus for instance to scan a specific region of the storage medium.

The read-out unit furthermore preferably uses a 100% transparent and/or a 0% transparent section as a trigger optionally for the start and/or the end of a determination of the average transmittance. It is particularly expedient if the determination of the average transmittance starts directly after the 100% transparent or 0% transparent section and/or ends directly before the 100% transparent or 0% transparent section. The signal value determined for the 100% transparent and/or the 0% transparent section can furthermore simultaneously be used for calibrating the read-out unit or sensor unit.

Particularly if the read-out of the storage medium is made more difficult owing to nonlinear properties of the storage medium or of the reading device, it may be expedient if the read-out unit uses the signal for additional partly transparent sections, which, however, are provided with different homogeneous transmittances of between 0% and 100%, for the calibration of the read-out unit or the sensor unit. The use of four such additional sections appears in such cases to enable particularly good results with regard to the read-out accuracy.

A radiation source that can be changed over between a shorter wavelength and a longer wavelength is provided as required. The read-out unit then determines the average transmittance in one case for the shorter wavelength and then for the longer wavelength, wherein the magnitudes of the average transmittance that are assigned to the wavelengths are read out, preferably in parallel. Afterward, the average transmittance and the read-out magnitude of the average transmittance are compared separately for each wavelength by the read-out unit.

The technical problem mentioned in the introduction is solved, in the case of a method for reading a storage medium, by means of the following steps:
the storage medium is irradiated at least in sections with electromagnetic radiation,
a sensor unit at least partly picks up the radiation after impingement on the storage medium and outputs a signal to a read-out unit,
an average transmittance of a partly transparent section of the storage medium is determined by the read-out unit at least from part of the signal,
the read-out unit, at least from part of the signal, reads out the magnitude of the average transmittance from an information content stored in the storage medium,
the average transmittance determined and the read-out magnitude of the average transmittance are compared with one another.

In order to read the storage medium, which is preferably effected by means of a reading device of the type described above, electromagnetic radiation is therefore directed onto the storage medium, wherein said radiation penetrates through at least one partly transparent section in part—as already denoted by a designation of said section—and is detected at least in part by a sensor unit. Depending on the radiation detected, the sensor unit outputs a signal to the read-out unit, which processes this signal further and ultimately determines an average transmittance of the partly transparent section therefrom. From the same signal or else from a further signal going back to further radiation detected in transmission by the sensor unit, the read-out unit furthermore determines an information content which is written to the storage medium and contains the magnitude of the average transmittance.

Through a comparison of the average transmittance determined and the read-out magnitude of the average transmittance, it is possible to ascertain, preferably in an automated manner and with high certainty, whether the data record stored on the storage medium has been manipulated or the entire storage medium has been copied in an unauthorized manner. This can then as required also permit a conclusion to be drawn about the authenticity not only of the storage medium as such but also of the carrier to which the storage medium is fitted.

The invention is explained in more detail below on the basis of exemplary embodiments, reference being made to the accompanying drawing. In the drawing:

FIG. 1 shows a storage medium applied to a carrier and having a 0% transparent and a 100% transparent section for triggering the start and the end of a determination of the average transmittance of the partly transparent section of 65%,

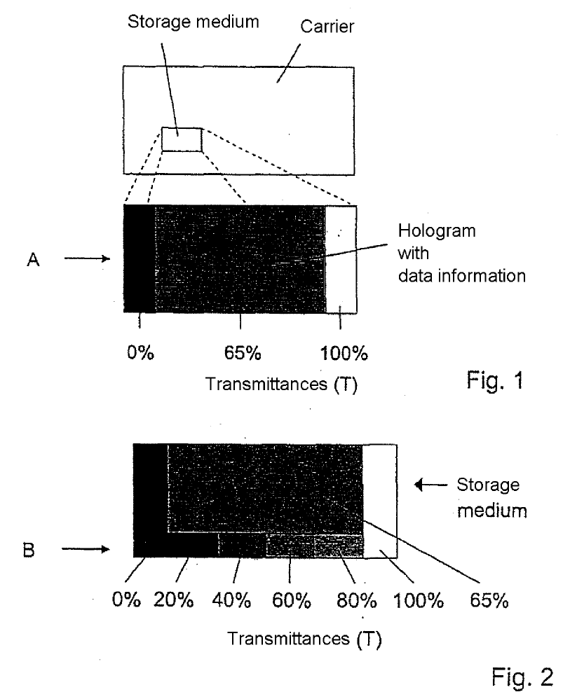

FIG. 2 shows the storage medium in accordance with FIG. 1 with additional partly transparent sections having homogeneous transmittances of between 0% and 100% for calibrating a reading device,

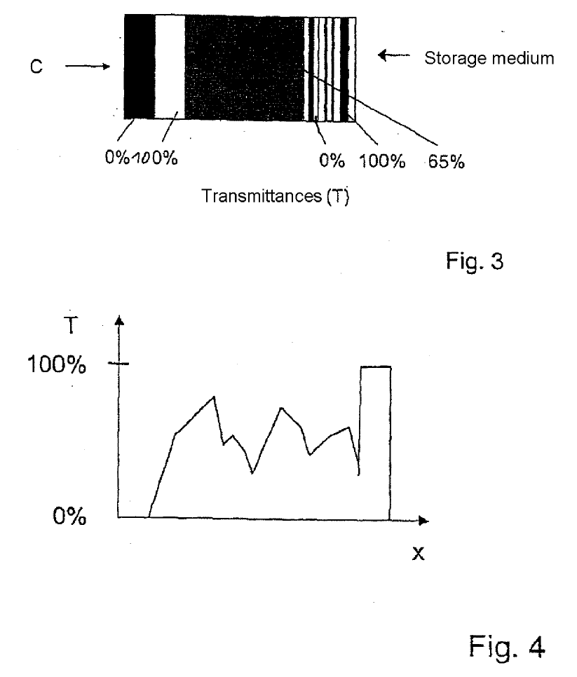

FIG. 3 shows a storage medium having a 0% transparent and a 100% transparent section for calibrating a reading device, a computer-generated hologram having an average transmittance of 65% and a 1D bar code,

FIG. 4 shows a plotting of the transmittance along the storage medium from FIG. 1 in the direction of the arrow A,

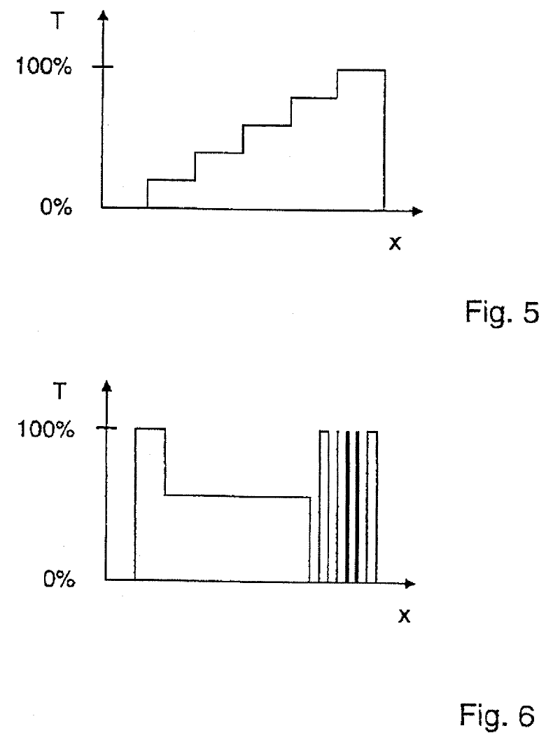

FIG. 5 shows a plotting of the transmittance along the storage medium from FIG. 2 in the direction of the arrow B, and

FIG. 6 shows a plotting of the transmittance along the storage medium from FIG. 3 in the direction of the arrow C.

FIG. 1 shows a carrier with a first exemplary embodiment of a storage medium according to the invention. This storage medium is shown in an enlarged illustration at the bottom of FIG. 1. The storage medium has a total of three sections having a different transmission. A section having 0% transmission is provided on the left-hand side, the middle section has a transmission of 65% and on the right there is an adjacent section having a transmission of 100%. The middle section is embodied as a computer-generated hologram and can therefore be read by means of a suitable reading beam, in particular a laser beam. Besides further information, the hologram has the information about the transmittance of the middle section of 65%. If the transmittance of the middle section is then measured and compared with the information from the reconstruction of the hologram, an authenticity check can be carried out.

FIG. 2 shows an extended configuration of the storage medium described above with reference to FIG. 1. Here, in addition to the middle section, a series of smaller sections having defined transmittances are arranged underneath. The transmittances are 20%, 40%, 60% and 80%. If these sections are measured separately, a calibration of the measured transmittance of the middle section arranged above them can then be carried out on the basis of the known transmittances. A calibration of this type may be necessary in particular when the material of the storage medium has nonlinear transmission properties.

FIG. 3 shows a further exemplary embodiment of a storage medium according to the invention. The following sections having a different transmission are situated from left to right: section having 0% transmission, section having 100% transmission, partly transparent central section having 65% transmission, and also a 1D bar code comprising a plurality of short sections having alternately 0% and 100% transmission. The central section is again embodied as a computer-generated hologram containing the transmittance 65% as at least one item of information. Furthermore, the bar code at least likewise has the information 65% transmission of the central section. This information is therefore present twice independently in the storage medium. And therefore, when the storage medium is read, the authenticity can be compared by comparing the measured transmission of the central section with the information stored twice.

In this case it is also possible for the central section not to be embodied as a hologram and to have only a uniformly distributed dot distribution having overall a transmission of 65%. The information 65% transmission is then contained only in the 1D bar code at the right-hand edge of the storage medium.

FIG. 4 shows a profile of the transmission along the storage medium if the transmission is determined continuously in the direction of the arrow A in FIG. 1. The transmission is firstly equal to zero, then exhibits an irregular profile during the middle section and then undergoes transition to a section having 100% transmission. Upon forming the integral over the transmission profile in the region of the middle section, the average transmission of 65% of said section is then obtained.

FIG. 5 shows the profile of the transmission along the path indicated by the arrow B in FIG. 2. A stepped profile can be discerned here, corresponding to the individual transmissions of the partial sections having 20 to 80%. This transmission profile can be used for calibration.

Finally, FIG. 6 shows the transmission profile over the storage medium along the path indicated by arrow C in FIG. 3. The initial change between 0% and 100% transmission can be discerned here before a region having a constant transmission of 65% follows. The typical bar code section that changes rapidly between 0% and 100% can then be seen on the right in FIG. 6.

1-22. (canceled)

23. A storage medium for a carrier, comprising
a transparent layer,
an opaque material layer,
wherein the layer of opaque material has a partly transparent section having an average transmittance of between 0% and 100% for electromagnetic radiation, and
wherein an information content comprising the magnitude of the average transmittance is stored in the storage medium.

24. The storage medium as claimed in claim 23,
wherein the areal distribution of the transmittance within the partly transparent section contains the information content comprising the magnitude of the average transmittance in coded form.

25. The storage medium as claimed in claim 23,
wherein at least one part of the partly transparent section is a computer-generated hologram containing the information content comprising the magnitude of the average transmittance.

26. The storage medium as claimed in claim 23,
wherein the layer of the opaque material has a transparent section having a transmittance of 100%.

27. The storage medium as claimed in claim 23,
wherein the layer of the opaque material has a non-transparent section having a transmittance of 0%.

28. The storage medium as claimed in claim 27,
wherein the 100% transparent section and the 0% transparent section delimit the partly transparent section at two mutually opposite sides.

29. The storage medium as claimed in claim 23,
wherein at least one additional partly transparent section having a predetermined transmittance of between 0% and 100% is provided.

30. The storage medium as claimed in claim 29,
wherein four additional partly transparent sections each having different transmittances of between 0% and 100% are provided.

31. The storage medium as claimed in any of claim 23,
wherein the partly transparent section has in each case a different transmittance of between 0% and 100% for electromagnetic radiation of a shorter wavelength (λ≦λₖ) and of a longer wavelength (λ≦λ₁; λₖ<<₁).

32. The storage medium as claimed in claim 31,
wherein the information content comprises the magnitudes of the average transmittances for the shorter wavelength and the longer wavelength.

33. The storage medium as claimed in claim 23,
wherein the average transmittance is set with relative accuracy of less than 5%.

34. The storage medium as claimed in claim 23,
wherein the average transmittance is set with an accuracy of ≦1%.

35. A reading device for a storage medium, as claimed in claims 23, comprising
a radiation source,
a sensor unit,
a read-out unit connected to the sensor unit, and
wherein the radiation source irradiates the storage medium at least in sections with electromagnetic radiation,
wherein the sensor unit at least partly picks up the radiation after impingement on the storage medium and outputs a signal to the read-out unit,
wherein the read-out unit determines an average transmittance of a partly transparent section of the storage medium at least from part of the signal,
wherein the read-out unit, at least from part of the signal, reads out the magnitude of the average transmittance from an information content stored in the storage medium, and
wherein the read-out unit compares the average transmittance determined and the read-out magnitude of the average transmittance with one another.

36. The reading device as claimed in claim 35,
wherein the read-out unit reads out the magnitude of the average transmittance from the radiation penetrating through the partly transparent section.

37. The reading device as claimed in claim 35,
wherein the read-out unit reads out the magnitude of the average transmittance from the areal distribution of the transmittance within the partly transparent section.

38. The reading device as claimed in claim 34,
wherein the read-out unit reads out the magnitude with the average transmittance from a reconstruction of a hologram.

39. The reading device as claimed in claims 34,
wherein a movement device that moves the radiation source and the storage medium relative to one another is provided, and
wherein the read-out unit uses a signal of the sensor unit for a transparent section having 100% transmittance and/or for a non-transparent section having 0% transmittance as a trigger for a start of the determination of the average transmittance.

40. The reading device as claimed in claim 38,
wherein the read-out unit uses the signal of the sensor unit for the transparent section having the transmittance of 100% and/or for the non-transparent section having a transmittance of 0% as a trigger for an end of the determination of the average transmittance.

41. The reading device as claimed in claim 34,
wherein the read-out unit uses the signal of the sensor unit for the transparent section having 100% transmittance and/or for the non-transparent section having 0% transmittance for calibrating the determination of the average transmittance.

42. The reading device as claimed in claim 34,
wherein the read-out unit uses the signal of the sensor unit for at least one additional partly transparent section having a transmittance of between 0% and 100% for calibrating the determination of the average transmittance.

43. The reading device as claimed in claim 34,
wherein the radiation source can be changed over between a shorter wavelength and a longer wavelength,
wherein the sensor unit picks up the radiation of the shorter wavelength and of the longer wavelength,
wherein the read-out unit determines the average transmittance in each case for the shorter wavelength and the longer wavelength and reads out the magnitude of the average transmittance, and
wherein the read-out unit compares the average transmittance determined and the read-out magnitude of the average transmittance in each case for the shorter wavelength and the longer wavelength with one another.

44. A method for reading a storage medium, preferably by means of a reading device as claimed in claim 34,
wherein the storage medium is irradiated at least in sections with electromagnetic radiation, in which a sensor unit at least partly picks up the radiation after impingement on the storage medium and outputs a signal to a read-out unit,
wherein an average transmittance of a partly transparent section of the storage medium is determined by the read-out unit at least from part of the signal,
wherein the read-out unit, at least from part of the signal, reads out the magnitude of the average transmittance from an information content stored in the storage medium, and wherein the average transmittance determined and the read-out magnitude of the average transmittance are compared with one another.
